(19) United States
(12) Patent Application Publication
(10) Pub. No.: US 2013/0342125 A1
(43) Pub. Date: Dec. 26, 2013

(54) DIMMING ANGLE SENSING CIRCUIT, DIMMING ANGLE SENSING METHOD, AND POWER SUPPLY DEVICE COMPRISING THE DIMMING ANGLE SENSING CIRCUIT

(71) Applicant: FAIRCHILD KOREA SEMICONDUCTOR LTD., Bucheon (KR)

(72) Inventors: Hyun-Chul EOM, Seoul (KR); Yong-Sang SHIN, Bucheon-si (KR)

(73) Assignee: FAIRCHILD KOREA SEMICONDUCTOR LTD., Bucheon (KR)

(21) Appl. No.: 13/920,550

(22) Filed: Jun. 18, 2013

Related U.S. Application Data
(60) Provisional application No. 61/661,939, filed on Jun. 20, 2012.

(30) Foreign Application Priority Data
May 23, 2013 (KR) 10-2013-0058581

(51) Int. Cl. H05B 33/08

(52) U.S. Cl. CPC H05B 33/0878
USPC 315/223

(57) ABSTRACT

A dimming angle sense circuit according to an exemplary embodiment of the present invention generates a source current that depends on an auxiliary voltage corresponding to an input voltage during a turn-on period of a power switch for a period during which an input is generated according to a dimming angle. The dimming angle sense circuit generates a dimming sense voltage by mirroring the source current, and generates a sampling voltage by sampling a dimming sense voltage for every turn-on period of a power switch. The dimming angle sense circuit generates a dimming signal by supplying a dimming current to a dimming resistor and a dimming capacitor according to a result of comparison between the sampling voltage and a reference voltage.

### CROSS-REFERENCE TO RELATED APPLICATION

This application claims priority to and the benefit of U.S. Patent Application No. 61/661, 939 filed in the USPTO on Jun. 20, 2012, and priority to and the benefit of Korean Patent Application No. 10-2013-0058581, filed with the Korean Intellectual Property Office on May 23, 2013, the entire contents of which are incorporated herein by reference.

### BACKGROUND OF THE INVENTION

(a) Field of the Invention

The present invention relates to a diming angle sense circuit, a dimming angle sensing method, and a power supply including a dimming angle sense circuit.

(b) Description of the Related Art

A triac dimmer passes each cycle of a sine wave of an AC input by a dimming angle. In order to control an output current supplied to a load (i.e., a lighting) using a current passed through the triac dimmer, a dimming angle should be sensed.

In further detail, when a dimmer is controller to control brightness of a lighting, an output current supplied to the lighting should be controlled according to a dimming angle. That is, the brightness of the lighting should be controlled to be increased as the dimming angle is increased and decreased as the dimming angle is decreased.

In order for the power supply to supply an output current to the lighting according to the dimming angle, information on the dimming angle is required. Otherwise, the power supply generates a constant output current without regard to the dimming angle and a switching duty of the power supply may be unnecessarily during such a process.

For example, although the dimming angle is controlled to be 90 degrees in order to reduce the brightness of the lighting to the half, the power supply may increase a switching duty to supply the same output current as in the case that the dimming angle is 180 degrees. That is, a malfunction of the power supply may occur.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a dimming angle sense circuit that can sense a dimming angle, a dimming angle sensing method, and a power supply including the dimming angle sense circuit.

A dimming angle sense circuit according to an exemplary embodiment of the present invention includes: a comparison circuit sensing a dimming angle using an auxiliary voltage that is a both-end voltage of an auxiliary coil that is coupled with a primary side coil coupled to an input voltage with a first turn ratio to generate a dimming sense signal; and a dimming signal generator generating a dimming signal that corresponds to the dimming angle using the dimming sense signal.

The comparison circuit includes a clamping circuit generating a source current that clamps a sense voltage that is a voltage of a second terminal of a first resistor that includes a first terminal coupled to the auxiliary voltage to a predetermined clamping voltage.

The clamping circuit includes a BJT including a first electrode coupled to the second terminal of the first resistor and a second electrode coupled to a first current source, a diode coupled with an anode coupled to a base of the BJT and a ground, and a second resistor including a first terminal coupled to the base of the BJT and a second terminal coupled to a first voltage.

The comparison circuit generates a mirror current by mirroring the source current, and generates the dimming sense signal by comparing a sampling voltage generated by sampling a dimming sense voltage generated by the mirror current flowing to a sense resistor for every predetermined sampling cycle and a predetermined reference voltage.

The dimming signal is used to control a switching operation of a power switch, and the predetermined sampling cycle is a switching cycle of the power switch.

The comparison circuit further includes a sampling/holding unit generating the sampling voltage by sampling and holding the dimming sense voltage by the switching cycle.

The dimming angle sense circuit further includes a comparator generating the dimming sense signal according to a result of comparison between the dimming sense voltage and the reference voltage.

The dimming signal generator includes a constant current source generating the dimming current, a transistor including a gate to which the dimming sense signal is input and a first electrode to which the dimming current is input, a dimming resistor coupled to a second electrode of the transistor, and a dimming capacitor coupled to the second electrode of the transistor and coupled in parallel with the dimming resistor.

The dimming signal generator measures a cycle of the dimming sense signal and a first level period, and generates the dimming signal by dividing the first level period of the dimming sense signal with the cycle of the dimming sense signal.

A dimming angle sensing method according to another exemplary embodiment of the present invention includes: generating an auxiliary voltage in a first terminal of an auxiliary coil that is coupled with a primary side coil, coupled to an input voltage, with a first turn ratio; supplying current to maintain a sense voltage of a second terminal of a first resistor that includes a first terminal coupled to the first terminal of the auxiliary coil with a predetermined clamping voltage; generating a dimming sense voltage according to a mirror current mirrored from the source current; generating a sampling voltage by sampling and holding the dimming sense voltage by a predetermined sampling cycle unit; and generating a dimming sense signal according to a result of comparison between the sampling voltage and a predetermined reference voltage.

The dimming angle sensing method further includes a dimming signal that corresponds to a dimming angle using the dimming sense signal.

The generating the diming signal may include flowing the dimming current to a dimming resistor and a dimming capacitor coupled in parallel with each other during a turn-on period of a transistor that performs switching according to the dimming sense signal.

The generating the dimming signal may include measuring a cycle and a first level period of the dimming sense signal and dividing the first level period of the dimming sense signal with the cycle of the dimming sense signal.

The generating the dimming sense voltage includes supplying the mirror current to sense resistor.

The supplying the source current includes supplying a source current to maintain the sense voltage with zero voltage when the auxiliary voltage has negative level.

A power supply according to another exemplary embodiment of the present invention includes: a primary side coil including a first terminal to which an input voltage rectified from an AC input passed through a dimmer is supplied; a power supply coupled to a second terminal of the primary side coil; an auxiliary coil coupled with the primary side coil with a first turn ratio; a first resistor including a first terminal coupled to a first terminal of the auxiliary coil; a dimming angle sense circuit generating a source current to maintain a sense voltage that is a voltage of a second terminal of the first resistor with a predetermined clamping voltage and generating a dimming signal corresponding to a dimming angle of the dimmer using the source current; and a switch control circuit controlling a switching operation of the power switch according to the dimming signal.

The dimming angle sense circuit generates a dimming sense voltage using a mirror current mirrored from the source current, generates a dimming sense signal according to a result of comparison between a sampling voltage generated by sampling the dimming sense voltage by a predetermined sampling cycle unit and a predetermined reference voltage, and generates the dimming signal using the dimming sense signal.

The dimming angle sense circuit includes: a transistor performing a switching operation according to the diming sense signal; a constant current source supplying a dimming current to a first electrode of the transistor; a dimming resistor including a first terminal coupled to a second electrode of the transistor; and a dimming capacitor including a first terminal coupled to the second electrode of the transistor. The dimming resistor and the dimming capacitor are coupled in parallel with each other and the dimming signal is a first terminal voltage of each of the dimming resistor and the dimming capacitor.

The dimming angle sense circuit measures a cycle and a first level period of the dimming sense signal and generates the dimming signal by dividing the first level period of the dimming sense signal with the cycle of the dimming sense signal.

The dimming angle sense circuit includes a first electrode coupled to a second terminal of the first resistor and a first current source, a diode coupled to an anode coupled to a base of the BJT and a ground, and a second resistor including a first terminal coupled to the base of the BJT and a second terminal coupled to a first voltage.

The predetermined sampling cycle unit is a switching cycle unit of the power switch.

The dimming angle sense circuit includes a sense resistor to which the mirror current flows, and the dimming sense voltage is a voltage of the sense resistor.

According to the exemplary embodiments of the present invention, a dimming angle sense circuit that can sense a dimming angle, a dimming angle sensing method, and a power supply including the dimming angle sense circuit are provided.

### BRIEF DESCRIPTION OF THE DRAWINGS

FIG. 1 shows a power supply to which a dimming angle sense circuit is applied according to an exemplary embodiment of the present invention.

FIG. 2 shows an input voltage, a dimming sense voltage, a dimming sense signal, a sampling voltage, and a dimming voltage according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

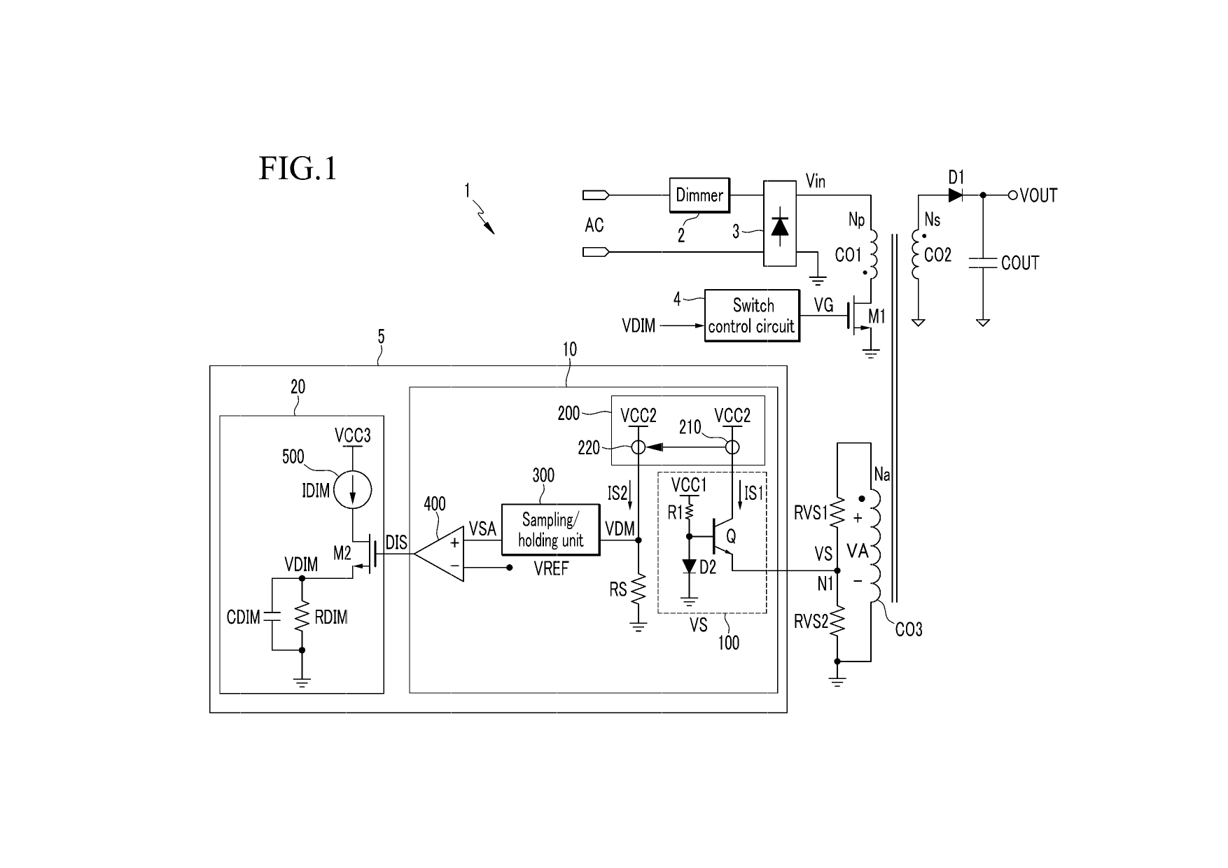

FIG. 1 shows a dimming angle sense circuit and a power supply including the same according to an exemplary embodiment of the present invention.

A power supply 1 supplies power to a load using an AC input AC. The power supply according to the exemplary embodiment of the present invention is realized as a flyback converter, but the present invention is not limited thereto.

The AC input passed through a dimmer 2 is full-wave rectified by a rectification circuit 3 and then generated as an input voltage Vin. A dimming angle of the dimmer 2 determines an AC input AC that passes through the dimmer 2. For example, the AC input AC passing through the dimmer 2 is increased as the dimming angle is increased, and when the dimming angle is 180 degrees, all AC input AC pass through the dimmer 2.

The input voltage Vin is supplied to a first terminal of a primary side coil CO1 and a second terminal of the primary side coil CO1 is coupled to a drain of the power switch M1. During a turn-on period of the power switch M1, a current flowing to the primary side coil CO1 is increased with a slope that depends on the input voltage Vln. Energy is stored in the primary side coil CO1 during the turn-on period of the power switch M1. When the power switch M1 is turned off, a rectification diode D1 is conducted so that a current flows to a secondary side coil CO2.

A output capacitor COUT is charged by the current passed through the rectification diode D1 such that an output voltage VOUT is generated.

A switch control circuit 4 generates a gate voltage VG that controls a switching operation of the power switch M1. In this case, the switch control circuit 4 receives a dimming voltage VDIM, and may generate the gate voltage VG to control an output current according to the dimming voltage VDIM.

For example, when the dimming voltage VDIM is proportional to the dimming angle, the switch control circuit 4 may decrease a switching frequency of the power switch M1 to reduce the output current as the dimming voltage VDIM is decreased.

The first coil CO1 in the primary side is coupled to the input voltage Vin. The power switch M1 is coupled between the first coil CO1 the ground. A turn ratio (Na/Np) between turns Na of an auxiliary coil CO3 and turns Np of the first coil CO1 is called wn1. The auxiliary coil CO3 and the first coil CO1 are coupled with the turn ratio wn1.

A second coil CO2 disposed in the secondary side is coupled to an output capacitor COUT through a rectification diode D1, and a turn ratio (Na/Ns) between turns Ns of the second coil CO2 and turns Ns of the auxiliary coil CO3 is called wn2. The auxiliary coil CO3 and the second coil CO2 are coupled with the turn ratio wn2.

When the power switch M1 is turned on, a voltage of the first coil CO1 becomes a negative input voltage Vin, and a negative voltage (−wn1*Vin) obtained by multiplying the turn ratio wn1 to the input voltage Vin is generated as a voltage VA (hereinafter, referred to as an auxiliary voltage) of the auxiliary coil CO3. A source current IS1 that depends on a difference between a voltage (hereinafter, referred to as a sense voltage) of a node N1 and the auxiliary voltage VA flows through a resistor RVS1.

A dimming angle sense circuit 5 includes a comparison circuit 10 and a dimming signal generator 20. The comparison circuit 10 senses a dimming angle using an auxiliary voltage VS that corresponds to the input voltage Vin, and the dimming signal generator 20 converts the sensed dimming angle to a dimming signal VDIM.

It is illustrated in FIG. 1 that the switch control circuit 4 and the dimming angle sense circuit 5 are separate blocks, but they may be formed as a single integrated circuit chip.

The comparison circuit 10 includes a clamping circuit 100, a current mirror circuit 200, a sampling/holding unit 300, a sense resistor RS, and a comparator 400. The dimming signal generator 20 includes a constant current source 500, a transistor M2, a dimming resistor RDIM, and a dimming capacitor CDIM.

The clamping circuit 100 clamps a sense voltage VS to zero voltage during the turn-on period of the power switch M1. In further detail, the auxiliary voltage VA is a negative voltage during the turn-on period of the power switch M1, and the source current IS1 flows to the auxiliary coil CO3 through the clamping circuit 100. In this case, the node N1 coupled to the clamping circuit 100 is the same as a potential of a cathode of a diode D2. Accordingly, the sense voltage VS is clamped to zero voltage.

Among the AC input AC, an input voltage Vin for a portion cut off by the dimmer 2 (i.e., a portion not included in the dimming angle) is zero voltage. In the portion, the auxiliary voltage VA is also zero voltage even through the power switch M1 is in the turn-on state, and therefore no current flowing to the auxiliary coil CO3 from the clamping circuit 100 is generated.

When the power switch M1 is turned off, the voltage of the second coil CO2 becomes a voltage obtained by adding a forward voltage of the rectification diode D1 to the output voltage VOUT. The auxiliary voltage VA becomes a positive voltage obtained by multiplying the turn ratio wn2 to the voltage of the second coil CO2. Then, no current flowing to the auxiliary coil CO3 from the second node N2 is generated. That is, the source current IS1 does not flow.

As described, when the auxiliary voltage VA is zero voltage or a positive voltage, the clamping circuit 200 is not operated and the source current IS1 does not flow. A period during which the source current IS1 is generated is only when the power switch M1 is in the turn-on state in a dimming angle period.

The clamping circuit 100 includes a resistor R1, a diode D2, and a BJT Q, and clamps the sense voltage VS to a predetermined clamping voltage during the turn-on period of the power switch M1. For example, the predetermined clamping voltage may be zero voltage. The source current IS1 generated during a clamping operation of the clamping circuit 100 is determined according to the auxiliary voltage VA, and since the auxiliary voltage VA depends on the input voltage Vin during the turn-on period of the power switch M1, the source current IS1 depends on the input voltage Vin.

The resistor R1 includes a first terminal to which a voltage VCC1 is input and a second terminal coupled to a base of the BJT Q. An anode of the diode D2 is coupled to the base of the BJT Q and a cathode of the diode D2 is coupled to the ground. A collector of the BJT Q is coupled to the current mirror circuit 200 and an emitter of the BJT Q is coupled to the node N1.

A threshold voltage (e.g., 0.7V) of the diode D2 is maintained with a base voltage of the BJT Q, and a threshold voltage of the BJT Q is set to be equal to a voltage of the diode D2. During the turn-on period of the power switch M1, the source current IS1 flowing through the BJT Q is generated, and in this case, the emitter voltage of the BJT Q corresponds to a voltage obtained by subtracting the threshold voltage from the base voltage of the BJT Q, and therefore the sense voltage VS is maintained with zero voltage.

The current mirror circuit 200 generates a mirror current IS2 by mirroring the source current IS2 flowing to the clamping circuit 100. The current mirror circuit 200 includes a first current source 210 and a second current source 220.

The first current source 210 is coupled between the voltage VCC2 and the BJT Q, and supplies the source current IS1 to the clamping circuit 100 using the voltage VCC2. The second current source 220 is coupled to the voltage VCC2, and generates a mirror current IS2 by mirroring the source current IS1 using the voltage VCC2. In the exemplary embodiment of the present invention, the source current IS1 and the mirror current IS2 are set to be equivalent to each other.

The mirror current IS2 flows to the sense resistor RS such that a dimming sense voltage VDM is generated.

The sampling/holding unit 300 samples the dimming sense voltage VDM for every switching cycle of the power switch M1 to generate a sampling voltage VSA, and holds the sampling voltage VSA. For example, the sampling/holding unit 300 generates the sampling voltage VSA during the turn-on period of the power switch M1, and holds the sampling voltage VSA until the next turn-on period of the power switch M1.

The comparator 400 generates a dimming sense signal DIS according to a result of comparison between the sampling voltage VSA and a reference voltage VREF. For example, the comparator 400 includes a non-inverse terminal (+) to which the sampling voltage VSA is input and an inverse terminal (−) to which the reference voltage VREF is input, and generates a high-level dimming sense signal DIS when the input of the non-inverse terminal (+) is higher than the input of the inverse terminal (−) and generates a low-level dimming sense signal DIS when the input of the non-inverse terminal (+) is lower than the input of the inverse terminal (−).

A high-level width of the dimming sense signal DIS depends on a dimming angle in the exemplary embodiment of the present invention. As the dimming angle is increased, the high level width of the dimming sense signal DIS is increased.

The dimming signal generator 20 generates a dimming signal VDIM according to the dimming sense signal DIS. The dimming signal generator 20 generates the dimming signal VDIM using a filtering circuit, or may generate the dimming signal VDIM by measuring a cycle of the dimming sense signal DIS and a high-level time of the dimming sense signal DIS and then dividing the high-level time of the diming sense signal DIS with the cycle.

It is illustrated in FIG. 1 that the dimming signal generator 20 uses the filtering circuit, and as previously stated, the present invention is not limited thereto.

The dimming signal generator 20 generates the dimming signal VDIM by controlling supply of the dimming current IDIM according to the dimming sense signal DIS. The dimming signal generator 20 includes a constant current source 500, transistor M2, a dimming resistor RDIM, and a dimming capacitor CDIM.

The constant current source 500 generates the dimming current IDIM using a voltage VCC3. The dimming sense signal DIS is input to a gate electrode of the transistor M2, a drain electrode of the transistor M2 is coupled to the constant current source 500, and a source electrode of the transistor M2 is coupled to a first terminal of the diming resistor RDIM and a first electrode of the dimming capacitor CDIM. The dimming resistor RDIM and the dimming capacitor CDIM are coupled in parallel with each other, the first terminal of the dimming resistor RDIM and the first electrode of the dimming capacitor CDIM are coupled to the source electrode of the transistor M2, and a second terminal of the dimming resistor RDIM and a second electrode of the dimming capacitor CDIM are coupled to the primary side ground.

While the transistor M2 is in the turn-on state by a high-level diming sense signal DIS, the dimming current IDIM flows to the dimming resistor RDIM and the dimming capacitor CIM such that a voltage is generated, and the voltage is the dimming signal VDIM.

As a high-level pulse width of the dimming sense signal DIS is increased, the turn-on period of the transistor M2 is increased and a period during which the dimming signal VDIM is generated is increased such that the dimming signal VDIM is increased.

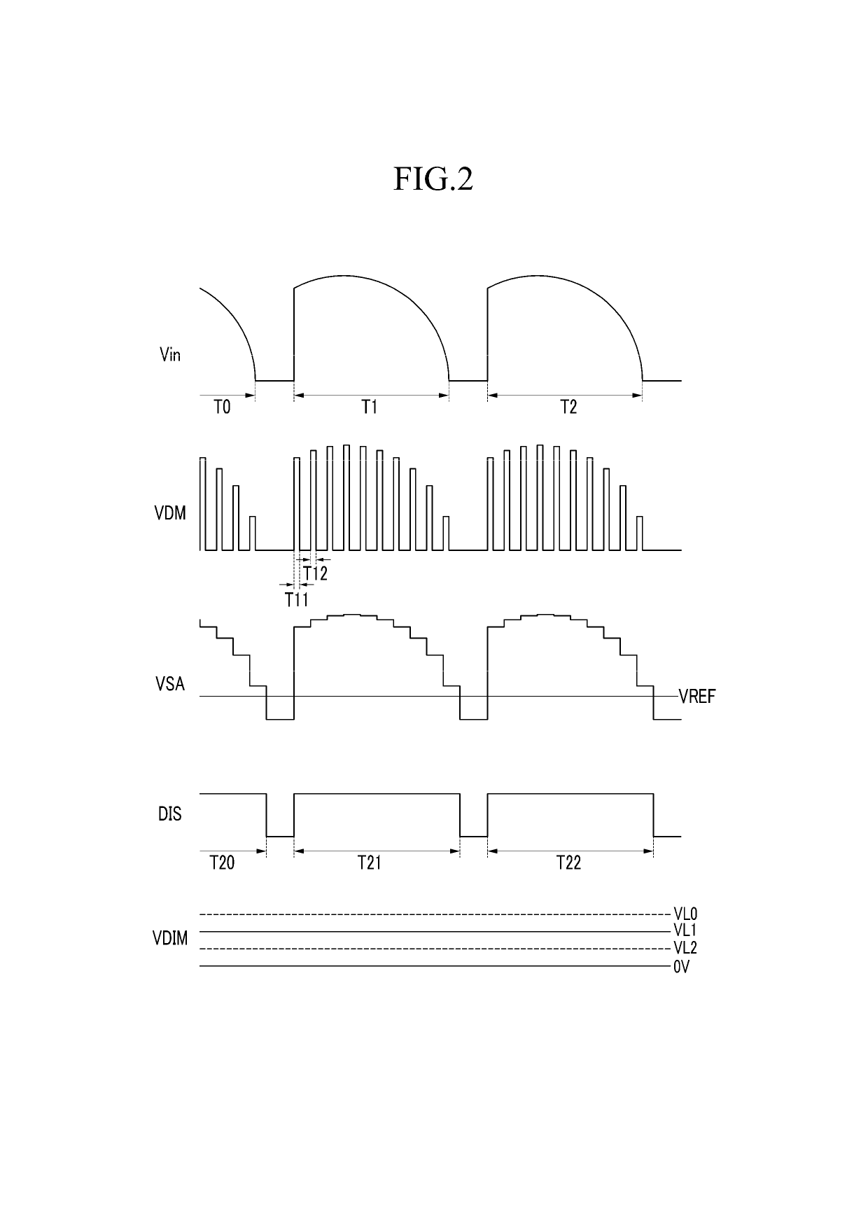

FIG. 2 shows an input voltage, a dimming sense voltage, a dimming sense signal, a sampling voltage, and a dimming voltage according to the exemplary embodiment of the present invention.

As shown in FIG. 2, the input voltage Vin has a waveform that depends on a dimming angle of the dimmer 2. In further detail, a portion of the AC input AC, not included in the dimming angle, is cut off and full-wave rectified such that the input voltage Vin is generated.

For a dimming angle period T0, T1, and T2 during which the input voltage Vin is generated, a dimming sense voltage VDM is generated during a turn-on period of the power switch M1. Since an auxiliary voltage VA is a negative voltage that depends on the input voltage Vin during the turn-on period of the power switch M1, the auxiliary voltage VA is decreased (the absolute value is increased) as the input voltage Vin is increased. On the contrary, the auxiliary voltage is increased (the absolute value is decreased) as the input voltage Vin is decreased.

A voltage difference between the sense voltage VS and the auxiliary voltage VA is increased as the input voltage Vin is increased so that the source current IS1 is increased. On the contrary, the voltage difference between the sense voltage VS and the auxiliary voltage VA is decreased as the input voltage Vin is decreased so that the source current IS1 is decreased.

The dimming sense voltage VDM is generated by a mirror current IS2 generated by mirroring the source current IS1, and therefore the dimming sense voltage VDM depends on the input voltage Vin. That is, the dimming sense voltage VDM is increased (or, decreased) as the input voltage Vin is increased (or, decreased).

For every turn-on period of the dimming sense voltage power switch M1, the dimming sense voltage VDM is sampled and thus a sampling voltage VSA is generated. The dimming sense voltage VDM is sampled in a turn-on period T11 and thus a sampling voltage VSA is generated and then held until the next turn-on period T12. The dimming sense voltage VDM is sampled in the turn-on period T12 and thus a sampling voltage VSA is generated and then held until the next turn-on period. Such an operation is iteratively performed.

A diming sense signal DIS is a high level signal for periods T20, T21, and T22 during which the sampling voltage VSA is higher than the reference voltage VREF. During the periods, the dimming resistor RDIM and the dimming capacitor CDIM are supplied with a dimming current IDIM so that a dimming voltage VDIM is generated. Accordingly, the dimming voltage VDIM has a level that depends on the dimming angle.

For example, a level VL1 of the dimming voltage VDIM shown in FIG. 2 is a value obtained by multiplying (dimming angle)/180 to a product of the dimming current IDIM and the dimming resistance RDIM. Thus, when the dimming angle is 180 degrees, the dimming voltage VDIM is IDIM*RDIM and is represented as VL0. When the dimming angle is 0 degrees, the dimming voltage VDIM has a level VL2 that is the half of the level VL0.

As described, according to the exemplary embodiment of the present invention, a method for sensing a dimming angle and a power supply including a dimming angle sense circuit can be provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

power supply 1, dimmer 2, rectification circuit 3
switch control circuit 4, dimming angle sense circuit 5
comparison circuit 10, dimming signal generator 20
clamping circuit 100, current mirror circuit 200, sampling/holding unit 300
comparator 400, constant current source 500
transistor M2, sense resistor RS, dimming resistor RDIM
dimming capacitor CDIM, resistor R1
rectification diode D1, diode D2, BJT(Q)

What is claimed is:

1. A dimming angle sense circuit comprising:
a comparison circuit configured to sense a dimming angle using an auxiliary voltage and further configured to generate a dimming sense signal based on the sensed dimming angle, the auxiliary voltage being a both-end voltage of an auxiliary coil coupled with a primary side coil coupled to an input voltage with a first turn ratio; and
a dimming signal generator configured to generate a dimming signal corresponding to the dimming angle using the dimming sense signal.

2. The dimming angle sense circuit of claim 1, wherein the comparison circuit comprises a clamping circuit configured to generate a source current based on a clamping of a sense voltage to a predetermined clamping voltage, wherein the sense voltage is a voltage of a second terminal of a first resistor that includes a first terminal coupled to the auxiliary voltage.

3. The dimming angle sense circuit of claim 2, wherein the clamping circuit comprises:
a BJT having a first electrode coupled to the second terminal of the first resistor and a second electrode coupled to a first current source;
a diode coupled between with an anode coupled to a base of the BJT and a ground; and
a second resistor having a first terminal coupled to the base of the BJT and a second terminal coupled to a first voltage.

4. The dimming angle sense circuit of claim 2, wherein the comparison circuit is configured to generate a mirror current by mirroring the source current and further configured to generate the dimming sense signal based on a comparison between a sampling voltage and a predetermined reference voltage, the sampling voltage being generated by sampling a dimming sense voltage generated by the mirror current flowing to a sense resistor for every predetermined sampling cycle.

5. The dimming angle sense circuit of claim 4, wherein the dimming signal is configured to be used to control a switching operation of a power switch, and the predetermined sampling cycle is a switching cycle of the power switch.

6. The dimming angle sense circuit of claim 5, wherein the comparison circuit further comprises a sampling/holding unit configured to generate the sampling voltage by sampling and holding the dimming sense voltage by the switching cycle.

7. The dimming angle sense circuit of claim 4, further comprising a comparator configured to generate the dimming sense signal based on a result of comparison between the dimming sense voltage and the reference voltage.

8. The dimming angle sense circuit of claim 1, wherein the dimming signal generator comprises:
a constant current source configured to generate the dimming current;
a transistor including a gate to which the dimming sense signal is input and a first electrode to which the dimming current is input;
a dimming resistor coupled to a second electrode of the transistor; and
a dimming capacitor coupled to the second electrode of the transistor and coupled in parallel with the dimming resistor.

9. The dimming angle sense circuit of claim 1, wherein the dimming signal generator is configured to measure a cycle of the dimming sense signal and a first level period and further configured to generate the dimming signal based on a division of the first level period of the dimming sense signal by the cycle of the dimming sense signal.

10. A dimming angle sensing method comprising:
generating an auxiliary voltage in a first terminal of an auxiliary coil, the auxiliary coil being coupled with a primary side coil, coupled to an input voltage with a first turn ratio;
supplying a source current to maintain a sense voltage of a second terminal of a first resistor having a first terminal coupled to the first terminal of the auxiliary coil with a predetermined clamping voltage;
generating a dimming sense voltage based on a mirror current mirrored from the source current;
generating a sampling voltage by sampling and holding the dimming sense voltage by a predetermined sampling cycle unit; and
generating a dimming sense signal based on a result of comparison between the sampling voltage and a predetermined reference voltage.

11. The dimming angle sensing method of claim 10, further comprising generating a dimming signal corresponding to a dimming angle using the dimming sense signal.

12. The dimming angle sensing method of claim 11, wherein generating the diming signal comprises flowing the dimming current to a dimming resistor and a dimming capacitor coupled in parallel with each other during a turn-on period of a transistor configured to perform switching based on the dimming sense signal.

13. The dimming angle sensing method of claim 11, wherein generating the dimming signal comprises:
measuring a cycle and a first level period of the dimming sense signal; and
dividing the first level period of the dimming sense signal by the cycle of the dimming sense signal.

14. The dimming angle sensing method of claim 10, wherein generating the dimming sense voltage comprises supplying the mirror current to a sense resistor.

15. The dimming angle sensing method of claim 10, wherein supplying the source current comprises supplying a source current to maintain the sense voltage with zero voltage when the auxiliary voltage has negative level.

16. A power supply comprising:
a primary side coil having a first terminal to which an input voltage is supplied, the input voltage being rectified from an AC input passed through a dimmer;
a power supply coupled to a second terminal of the primary side coil;
an auxiliary coil coupled with the primary side coil with a first turn ratio;
a first resistor having a first terminal coupled to a first terminal of the auxiliary coil;
a dimming angle sense circuit configured to generate a source current to maintain a sense voltage with a predetermined clamping voltage, the sense voltage being a voltage of a second terminal of the first resistor, the dimming angle sense circuit being further configured to generate a dimming signal corresponding to a dimming angle of the dimmer using the source current; and
a switch control circuit configured to control a switching operation of the power switch based on the dimming signal.

17. The power supply of claim 16, wherein the dimming angle sense circuit is configured to generate a dimming sense voltage using a mirror current mirrored from the source current, the dimming angle sense circuit being further configured to generate a dimming sense signal based on a result of a comparison between a sampling voltage and a predetermined reference voltage, the sampling voltage being generated by sampling the dimming sense voltage by a predetermined sampling cycle unit, the dimming angle sense circuit being further configured to generate the dimming signal using the dimming sense signal.

18. The power supply of claim 17, wherein the dimming angle sense circuit comprises:
a transistor configured to perform a switching operation based on the diming sense signal;
a constant current source configured to supply a dimming current to a first electrode of the transistor;
a dimming resistor having a first terminal coupled to a second electrode of the transistor; and
a dimming capacitor having a first terminal coupled to the second electrode of the transistor, and
wherein the dimming resistor and the dimming capacitor are coupled in parallel with each other and the dimming signal is a first terminal voltage of each of the dimming resistor and the dimming capacitor.

19. The power supply of claim 17, wherein the dimming angle sense circuit is configured to measure a cycle and a first level period of the dimming sense signal and to generate the dimming signal based on a division of the first level period of the dimming sense signal by the cycle of the dimming sense signal.

20. The power supply of claim 17, wherein the dimming angle sense circuit comprises:
a first electrode coupled to a second terminal of the first resistor and a first current source;
a diode coupled to an anode coupled to a base of the BJT and a ground; and
a second resistor having a first terminal coupled to the base of the BJT and a second terminal coupled to a first voltage.

21. The power supply of claim 17, wherein the predetermined sampling cycle unit is a switching cycle unit of the power switch.

22. The power supply of claim 16, wherein the dimming angle sense circuit comprises a sense resistor to which the mirror current flows and the dimming sense voltage is a voltage of the sense resistor.
